(19) United States
(12) Patent Application Publication
(10) Pub. No.: US 2008/0197952 A1
(43) Pub. Date: Aug. 21, 2008

(54) Three-phase Transformer

(75) Inventor: Feng Jin Wang, Shenzhen (CN)

Correspondence Address: GLOBAL IP SERVICES, 7285 W. Eagle Court, Winton, CA, 95388, US

(73) Assignee: Shenzhen Putly Optic-Electronic Technology Co., Ltd., Shenzhen (CN)

(21) Appl. No.: 12/031,694

(22) Filed: Feb. 14, 2008

(30) Foreign Application Priority Data
Feb. 16, 2007 (CN) 200710073378.4
Feb. 16, 2007 (CN) 200710073379.9
Feb. 16, 2007 (CN) 200710073380.1

(51) Int. Cl. H01F 30/12

(52) U.S. Cl. 336/5

(57) ABSTRACT

The present invention relates to a transformer, and more especially to provides a three-phase transformer. The three-phase transformer includes three single-phase transformers; each single-phase transformer has a plurality of magnetic circuits and windings; said winding is formed by conducting wires continuously crossing through said magnetic circuits of each single-phase transformer in turn on a direction perpendicular to said magnetic circuit. In accordance with the present invention, the three-phase transformer has a simple structure and reduced volume. In addition, the heat radiation is good and then decreases the wastage. Moreover, the craft is simplified and the cost is reduced. The three-phase transformer may input and output larger electric current.

### CROSS-REFERENCE TO THE RELATED APPLICATIONS

This application claims the benefit of Chinese Applications No. 200710073380.1, 200710073379.9, 200710073378.4, all filed Feb. 16, 2007, the entire contents of which are incorporated herein by reference.

### FIELD OF THE INVENTION

The present invention relates to a transformer, and more especially to a three-phase transformer.

### BACKGROUND OF THE INVENTION

A transformer is an apparatus that transforms the alternating voltage, the electric current and the impedance. The transformer includes ferrite core and a coil which has two or more windings. The winding and ferrite core are called electric power transformer body that is electric circuit part of establishing the magnetic field and transferring electrical energy. In principle, the ferrite core is magnetic circuit of composing the transformer that can make the electrical energy transform into the magnetic energy and make the magnetic energy into the electrical energy. Therefore, the ferrite core is the energy transfer medium body. In structure, the ferrite core is framework of the transformer. Insulation coils are put on the column of the ferrite core that are supported reliably and compacted firmly.

The transformer could be divided into two main kinds of single-phase and the three-phase according to phases. At present, the existing three-phase transformer includes a ferrite core having three columns and a single magnetic circuit structure (relating to each phase of the three-phase transformer) surrounding on a main winding (primary winding) of the three columns ferrite core and three secondary winding. However, the structure is complex, has a large volume and great wastage, and heat radiation is difficult. Additionally, the conducting wire surrounding the ferrite core repeatedly forms the winding. Therefore, there is big craft limit. The input and output currents are extremely restricted. Moreover, it requires too much for manufacturing materials of the windings, machine process and manufacturing environment, which increases the cost.

### SUMMARY OF THE INVENTION

A primary object of the present invention is to provide a three-phase transformer which for the purpose of solving the existing the single magnetic circuit structure of three-phase transformer making the structure be easy, the volume be small, heat radiation be easy, loses in a small way, production cost low.

To achieve the above-mentioned object, a three-phase transformer is provided which includes: three single-phase transformers; each single-phase transformer has a plurality of magnetic circuits and windings and said the winding is formed by conducting wires continuously crossing through said a plurality of magnetic circuits of each single-phase transformer in turn on a direction perpendicular to said magnetic circuit.

In accordance with the present invention, the three-phase transformer has a simple structure and reduced volume. In addition, the heat radiation is good and then decreases the wastage. Moreover, the craft is simplified and the cost is reduced. The three-phase transformer may input and output larger electric current.

Other objects, advantages and novel features of the present invention will become more apparent from the following detailed description when taken in conjunction with the accompanying drawings, in which:

### BRIEF DESCRIPTION OF THE DRAWINGS

FIG. 1 is a structural drawing of a three-phase transformer in a first embodiment in accordance with the present invention;

FIG. 2 is a structural drawing of a three-phase transformer in a second embodiment in accordance with the present invention;

FIG. 3 is a structural drawing of a three-phase transformer in a third embodiment in accordance with the present invention;

FIGS. 4a and 4b are the structural drawings of a three-phase transformer of a fourth embodiment in accordance with the present invention.

### DETAILED DESCRIPTION OF THE INVENTION

The three-phase transformer of the present invention includes three single-phase transformers, each single-phase transformer has a plurality of magnetic circuits and windings 2 and the winding 2 is formed by conducting wires continuously crossing through a plurality of magnetic circuits of each single-phase transformer in turn on a direction perpendicular to the magnetic circuit.

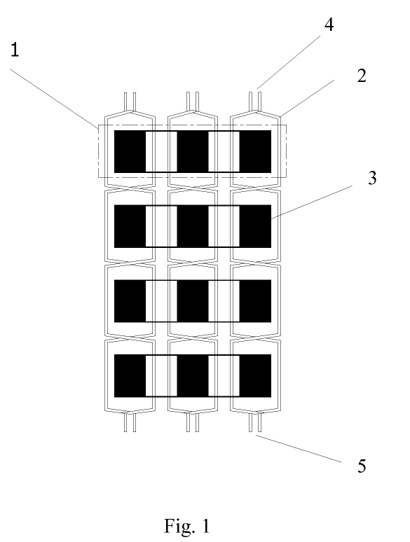

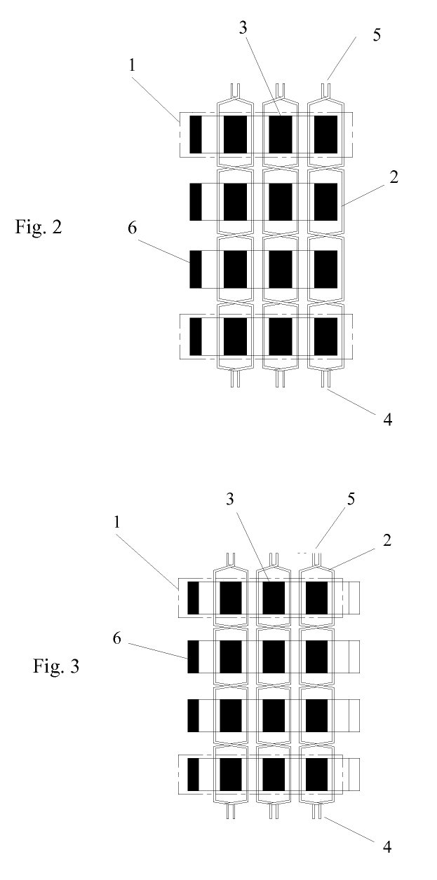

FIG. 1 is the structure of three-phase three columns transformer in the first embodiment. The crosswise arrangement is the ferrite core 3, the longitudinal arrangement is three groups windings 2 of the three-phase three columns transformer, from left to right in turn are three phases of the three-phase transformer, above is the input 5, under is the output 4. The direction of input 5 and output 4 can be disposed according to actual need. The distance among the ferrite cores 3 (i.e. distance among the three phases and distances among the ferrite cores 3 of different groups) are connected closely with the output power, which can be designed according to operating requirements. Through separately exerts three differ 120 degrees three-phase voltages to three single-phase transformers' primary, realizing the standard function of three-phase power frequency transformer.

In this structure, the three single-phase transformers are formed by a plurality of sub-three-phase three columns transformers, each magnetic circuit of sub-three-phase three columns transformer forms one magnetic circuit unit 1 of the three-phase three columns transformer, the magnetic circuit of a plurality of sub-three-phase three columns transformer form the three-phase three columns transformer's multiple magnetic circuit structure.

FIG. 3 is the structure of three-phase five columns transformer in the third embodiment. In order to avoid the one phase of three-phase transformer expiring causes the three-phase transformer the magnetic saturation, generally uses the three-phase five columns transformer structure, namely increases two side attachment yokes to replace the other two magnetism return routes in the original three-phase transformer when some one phase of the three-phase transformer abnormal. The crosswise arrangement is the ferrite core 3, the longitudinal arrangement is three groups windings 2 of the three-phase five columns transformer, from left to right in turn are the first side attachment yoke 61, three phases and the second side attachment yoke 62, above is the input 5, under is the output 4. The direction of input 5 and output 4 can be disposed according to actual need. The distance among the ferrite cores 3 (i.e. distance among the three phases and distances among the ferrite cores 3 of different groups) are connected closely with the output power, which can be designed according to operating requirements. Through separately exerts three differ 120 degrees three-phase voltages to three single-phase transformers' primary, realizing the standard function of three-phase power frequency transformer.

In this structure, the three single-phase transformers are formed by a plurality of sub-three-phase five columns transformers, three sub-single-phase transformers of each sub-three-phase five columns transformer share one side attachment yoke 6. Each magnetic circuit of sub-three-phase five columns transformer form one magnetic circuit unit 1 of the three-phase five columns transformer, the magnetic circuit of a plurality of sub-three-phase five columns transformer forms the three-phase five columns transformer's multiple magnetic circuit structure.

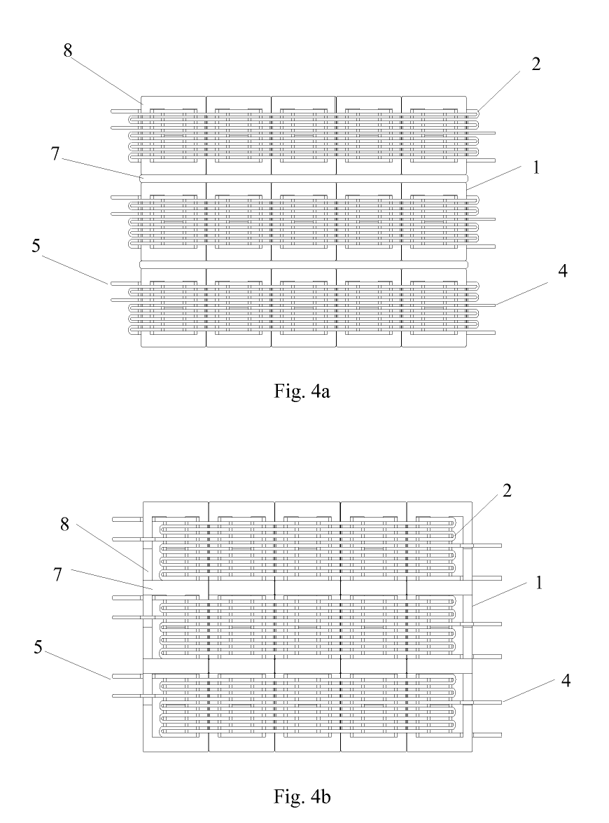

FIGS. 4a and 4b show the structure of three-phase three columns transformer in the fourth embodiment. Selected the vertical stack method, is equal to three single-phase transformers vertical combinations, from bottom to top in turn is three phases of the three-phase transformer, left side is the input 5, right side is the output 4. The direction of input 5 and output 4 can be disposed according to actual need.

Each single-phase transformer is the multiple magnetic circuits' structure. The winding 2 is formed by conducting wires continuously crossing through said magnetic circuits of each single-phase transformer in turn on a direction perpendicular to said magnetic circuit, and respectively surrounds a plurality of magnetic circuits. The winding 2 along the direction perpendicular to the ferrite core 3 of the transformer lays aside (inserts), as shown in FIG. 1.

As shown in FIG. 4a, each single-phase transformer uses the yoke 7 alone, so its manufacture method is convenient. If in between the two phases use the yoke 7 altogether, may save the about 15% ferrite core 3 materials.

Moreover, in this structure may reserve the side yoke 8, As shown in FIG. 4b, the availability rate of the ferrite core 3 drops, but it is good to the winding 2.

In accordance with the present invention, the three single-phase transformers use the yoke 7 separately or together, each single-phase transformer reserves the side yoke 8.

In the present invention, there are at least one input winding (as reactor or autotransformer) and one output winding (as isolating transformer) in each single-phase transformer of three-phase transformer, each winding may has different central tap according to actual need.

In the present invention, the conducting wire of winding 2 is an enameled wire or a flat electric conduction plate.

In accordance with the present invention, the three-phase transformer has a simple structure and reduced volume. In addition, the heat radiation is good and then decreases the wastage. Moreover, the craft is simplified and the cost is reduced. The three-phase transformer may input and output larger electric current.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A three-phase transformer, comprising:
three single-phase transformers;
wherein each single-phase transformer has a plurality of magnetic circuits and windings and said winding is formed by conducting wires continuously crossing through said magnetic circuits of each single-phase transformer in turn on a direction perpendicular to said magnetic circuit.

2. The three-phase transformer as claimed in claim 1, wherein said three single-phase transformers are formed by a plurality of sub-three-phase three columns transformers, each magnetic circuit of sub-three-phase three columns transformer forms one magnetic circuit unit of said three-phase three columns transformer, the magnetic circuits of said sub-three-phase three columns transformers form a multiple magnetic circuit structure of said three-phase three columns transformers.

3. The three-phase transformer as claimed in claim 1, wherein said three single-phase transformers are formed by a plurality of sub-three-phase four columns transformers, three sub-single-phase transformers of each sub-three-phase four columns transformer share one side attachment yoke; each magnetic circuit of sub-three-phase four columns transformer is one magnetic circuit unit of said three-phase four columns transformer, the magnetic circuit of said sub-three-phase four columns transformer form a multiple magnetic circuit structure of said three-phase four columns transformers.

4. The three-phase transformer as claimed in claim 1, wherein said three single-phase transformers are formed by a plurality of sub-three-phase five columns transformers, three sub-single-phase transformers of each sub-three-phase five columns transformer share two side attachment yokes; each magnetic circuit of sub-three-phase five columns transformer is one magnetic circuit unit of said three-phase five columns transformer, the magnetic circuit of said sub-three-phase five columns transformer form multiple magnetic circuit structure of said three-phase five columns transformers.

5. The three-phase transformer as claimed in claim 1, wherein the combination way of said three single-phase transformers is the vertical combination.

6. The three-phase transformer as claimed in claim 5, wherein said three single-phase transformers use yoke separately or together.

7. The three-phase transformer as claimed in claim 5, each single-phase transformer reserves side yoke.

8. The three-phase transformer as claimed in claim 1, wherein said conducting wire is an enameled wire or a flat electric conduction plate.

9. The skid-proof mat as claimed in claim 8, wherein said thermoplastic elastic material is thermo plastic rubber or thermo plastic elastomer.

10. The three-phase transformer as claimed in claim 1, each single-phase transformer includes at least one input winding and at least one output winding.
